(19) United States
(12) Patent Application Publication
(10) Pub. No.: US 2008/0084578 A1
(43) Pub. Date: Apr. 10, 2008

(54) QUALITY OF SERVICE METHODS AND SYSTEMS FOR MOBILE PRINTING

(75) Inventors: Jeffrey W. Walker, Windham, NH (US); Mark J. Thirman, Wayland, MA (US); Peter K. Fichter, Newbury, NH (US); Samuel H. Liggero, Wellesley, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: AIRPRINT NETWORKS, INC., Framingham, MA (US)

(21) Appl. No.: 11/868,280

(22) Filed: Oct. 5, 2007

Related U.S. Application Data
(63) Continuation-in-part of application No. 11/295,679, filed on Dec. 6, 2005.
(60) Provisional application No. 60/633,961, filed on Dec. 7, 2004.

(51) Int. Cl. G06F 3/12

(52) U.S. Cl. 358/1.15

(57) ABSTRACT

Systems and methods for secure, remote printing includes a mobile device (e.g., cell phone or PDA) establishing a secure communication connection with a mobile printer and a server, such a connection using one or more encryption protocols (e.g., SSL, TLS, etc.). The server encrypts the requested data and transmits it to the printer via the secure connection, whereon the printer decrypts and prints the data. The mobile device can, according to other aspects of the invention, logs operational performance characteristic of the printer, the server, and/or the communication connections therebetween. A media cartridge can be provided includes an enclosure having a substantially planar shape, wherein each of its length and width dimensions are greater than its height. An opening is disposed along a width-wise edge (e.g., a “front” of the enclosure), and one or more regions are also disposed on opposing length-wise edges (e.g., a “left side” and a “right side” of the enclosure). The regions permit a user to see and/or exert a force on sheet media (e.g., paper) contained within the enclosure.

### CROSS REFERENCE TO RELATED APPLICATIONS

This application is a continuation-in-part of U.S. patent application Ser. No. 11/295,679, filed Dec. 6, 2005, entitled “Subscriber Service and Micro-Printer for Remote, Mobile Printing,” which claims the benefit of U.S. Provisional Patent Application Ser. No. 60/633,961, filed Dec. 7, 2004, the entire contents of all of which are hereby incorporated by reference herein.

### BACKGROUND OF THE INVENTION

The invention pertains to telecommunications and remote data memorialization. More particularly, it pertains to methods and apparatus for the provision of telecommunications subscriber services and remote printing.

A number of options exist for data to be gathered and to be printed and preserved on permanent media. Much of this data is provided from but not limited to the Web. The most common method for converting this data into printed form is by fixed printing devices as for example a printer connected to a computer. While many computers and printers today are transportable, they are not conveniently carried on one's person.

There is an increasing proliferation of portable communications devices, such as cellular telephones and personal data assistants (PDAs). To date, output from these devices has typically been audio and visual. Though these are suitable for many needs, such output does not address the wide ranging demands that might otherwise be met if that output could be permanently memorialized. Those demands include, by way of example, business transactions, remote data presentation, and so forth.

An object of this invention is to provide methods and apparatus for telecommunications service provision data memorialization. A more particular object, by way of example, is to provide such methods and apparatus for the provision of telecommunications subscriber services. A further object is to provide such methods and apparatus as permit the permanent (or semi-permanent) memorialization of output from portable communications devices, such as cellular phones and PDAs.

A still further object of the invention is to provide such methods and apparatus as can be implemented on top of a variety of telecommunications networks and/or with a variety of portable communications devices.

A still yet further object of the invention is to provide such methods and apparatus as can be implemented at low cost.

### SUMMARY OF THE INVENTION

The foregoing are among the objects attained by the invention which provides, among other aspects, methods and apparatus for telecommunications and/or network subscriber services and printing that enable portable communication device users (or “subscribers”) to print data and transactional content remotely, e.g., without having to dock with a personal computer.

Related aspects of the invention provide such methods and apparatus as employed in connection with remote printing of items of value such as, by way of non-limiting example tickets to entertainment events and coupons, micro-maps, content-of-the-day, transportation tickets, and more.

Still other related aspects of the invention provide such methods and apparatus which enable disparate content providers the ability to “lock” content into a format compatible with designated remote client application and printer interface applications.

Yet other related aspects of the invention provide such methods and apparatus which include content management capabilities that allow control of stored content by subscribers, including, by way of example, storing, printing, reporting, error reporting, and deleting such content.

The invention provides, in further aspects, systems and methods for transferring data over a telecommunications network to a remote device (such as a PDA or cellular phone), executing a commercial or other transaction on that device, providing secure and verifiable exchange of data over the network to the device, and printing that data on the device.

Related aspects of the invention provide such systems and methods in which printing, at the remote device, is effected on a portable, conveniently configurable, light weight and inexpensive printer. Further related aspects of the invention provide systems and method as described above in which the data to be printed is obtained from a data server that is coupled to the telecommunications network.

Still other related aspects of the invention provide such methods in which data transfer over the network and/or to the remote device is made through a permanent connection (such as a cable or interface connector), a wireless connection (such as Bluetooth, IrDA, WiFi), or otherwise.

In further related aspects, the invention provides such systems and methods in which data, once received by at the remote device, is converted from machine readable form to human readable form by the printer, resulting in a permanent paper record of the data to be used by the subscriber.

Other aspects of the invention provide systems and methods as described above in which images or other information recorded by the remote device itself (e.g., by way of an on-board camera, voice recorder, or the like) is recorded directly to the printer, e.g., irrespective of the telecommunications network.

Still other aspects of the invention provide such systems and methods as described above in which such information recorded or generated by the remote device (such as images, voice recording, reports, etc.) and/or the printer are transferred via the remote device, over the telecommunications network, to a central location. That information is then manipulated to alter or enhance the data content and retransmitted (e.g., either automatically or on subscriber request) to the remote device for printing, as described above.

Printer Encryption/Decryption

The foregoing objects are among those attained by the invention which provides, in still other aspects, methods and systems for secure, remote, mobile printing, e.g., without having to dock with a personal computer. In one aspect, the system includes a mobile device (e.g., cell phone or PDA) that establishes secure communication connections with a mobile printer and with a server, e.g., using one or more encryption protocols such as SSL or TLS. The mobile device transmits a request for data (e.g., movie ticket, web page, etc.) to the server via the secure connections. The server obtains the requested data, encrypts it and transmits it to the printer over the secure connections and via the mobile device. The printer decrypts and prints the data.

Still further aspects of the invention provide such systems for secure, remote printing, wherein the server encrypts the data with a session key generated by the printer and a private key associated the printer. Related aspects of the invention provide such systems wherein the printer decrypts the data with that same session key, and a private key associated with the printer. Further related aspects of the invention provide such systems wherein the session key is transmitted from the printer to the mobile device, and from the mobile device to the server. Further aspects of the invention provide such systems for secure, remote printing, wherein the printer generates the session key as a random number.

Further aspects of the invention provide such systems for secure, remote printing, wherein the data represents any of a movie ticket, web page, image data, or text data. In a related aspect of the invention, the server obtains the requested data from a source external to the server (e.g., from a content provider), and/or generates that data from content residing on the server, e.g., in a client mailbox.

Yet further aspects of the invention provide methods paralleling the operation of the systems described above.

QoS

The foregoing are among the objects attained by the invention which provides, among other aspects, methods and systems for user experience quality monitoring in mobile printing systems. In one aspect, the system includes a mobile device (e.g., cell phone or PDA) that establishes communication connections with a mobile printer and with a server. The mobile device executes a monitor application that logs operational performance characteristics of the mobile device itself, the mobile printer, the server, and/or the communication connections.

Further aspects of the invention provide such systems, wherein the monitor application uses the aforementioned performance characteristics in order to generate, and log, diagnostic data identifying potential problems with any of the mobile device, printer, server, and/or communication connections.

Still further aspects of the invention provide such system, wherein the monitor application transmits the aforementioned performance characteristics and/or diagnostics from the mobile device to the server, e.g., for further analysis and treatment by an administrator.

Further aspects of the invention provide such systems, wherein the mobile device is coupled to a carrier network, and the monitor application logs performance characteristics of that carrier network.

Further aspects of the invention provide such system, wherein the monitor application additionally logs print transactions executed by a user.

In a related aspect of the invention, the monitor application displays to a system administrator (or others) a status of logged print transactions.

In another related aspect of the invention, the status of a logged print transaction includes one or more values (such as, by way of non-limiting example, battery level and printer error codes, etc.) associated with any of a pending print transaction, completed print transaction, or a failed print transaction.

Yet further aspects of the invention provide methods paralleling the operation of the systems described above.

Media Cartridge

The foregoing are among the objects attained by the invention which provides, among other aspects, media cartridges and methods for use in a mobile printing system. In one aspect, the media cartridge includes an enclosure having a substantially planar shape, wherein each of its length and width dimensions are greater than its height. An opening is disposed along a width-wise edge (e.g., a “front” of the enclosure), and one or more regions are also disposed on opposing length-wise edges (e.g., a “left side” and a “right side” of the enclosure). The regions permit a user to exert a force on sheet media (e.g., paper) contained within the enclosure.

In further aspects of the invention, the regions disposed on opposing length-wise edges permit a user to see and/or grasp the sheet media.

In still further aspects of the invention, the enclosure has a removable cover that is removed prior to insertion of the enclosure into a mobile printer. In a related aspect of the invention, the removable cover is disposed along the width-wise edge having the aforementioned opening, thereby covering that opening, and at least one of (i) protecting the media during transport and handling and (ii) preventing the media from falling out of the enclosure prior to insertion into the mobile printer.

In other aspects of the invention, the enclosure is fashioned for insertion into the mobile printer, which extracts the media through the opening disposed along the aforesaid opening.

Yet further aspects of the invention provide methods paralleling the operation of the media cartridge described above.

The foregoing and other aspects of the invention are evident in the drawings and in the discussion that follows.

### BRIEF DESCRIPTION OF THE DRAWINGS

A more complete understanding of the invention may be attained by reference to the drawings, in which:

FIG. 1 depicts a system according to one practice of the invention; and

FIG. 2 depicts a system for user quality experience monitoring in a mobile printing system according to one practice of the invention;

FIG. 3A-D depict an operation flow for the embodiment depicted in FIG. 2; and

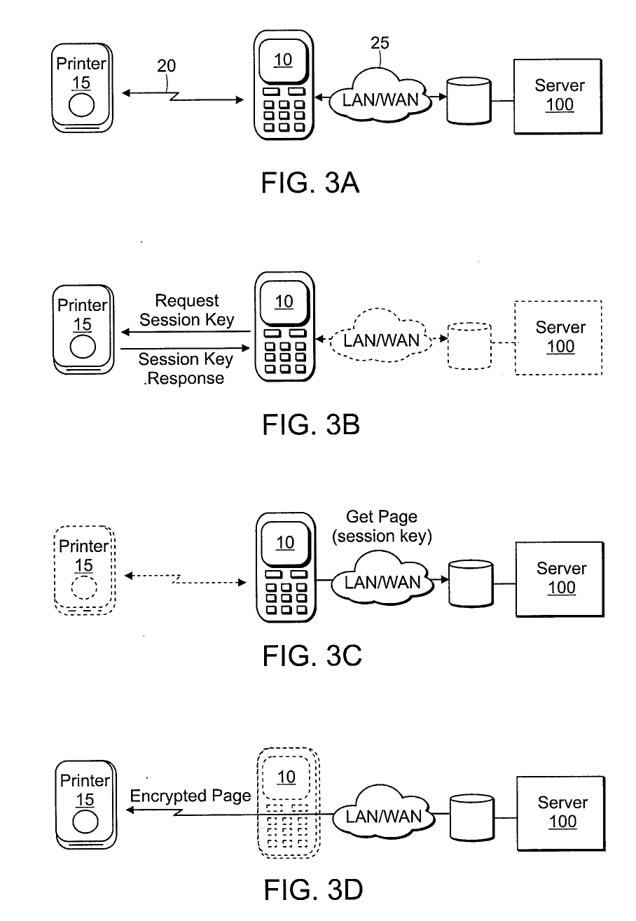

FIGS. 4A-4D depict a media cartridge according to one practice of the invention.

### DETAILED DESCRIPTION OF THE ILLUSTRATED EMBODIMENT

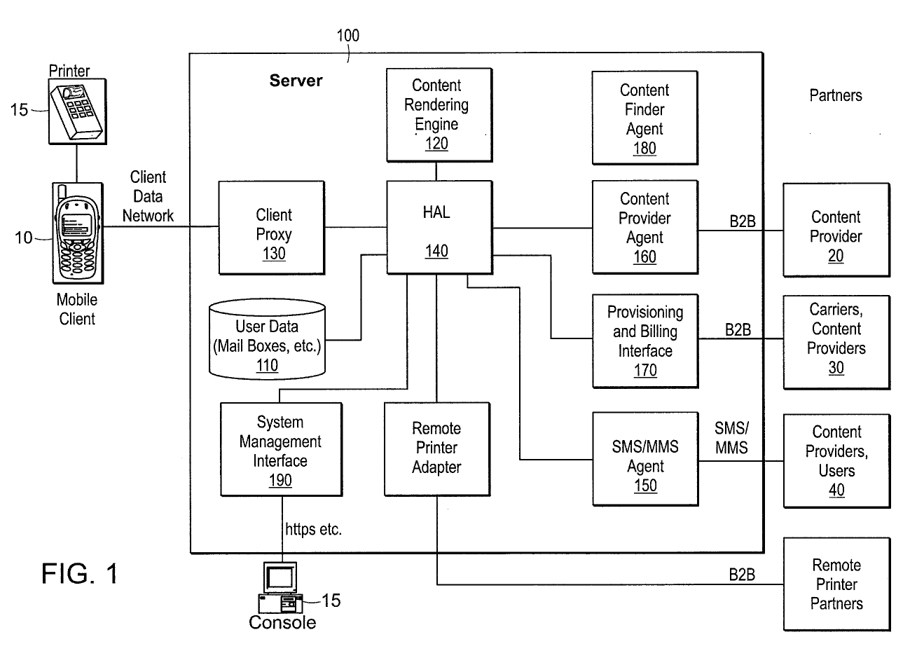

FIG. 1 depicts one embodiment of system according to the invention for provision of telecommunications subscriber services and remote printing. Descriptions of the components of the illustrated embodiment, and their interrelationships, follow. Those skilled in the art will appreciate that other embodiments may have few components or other components, in addition to or instead of those shown here, and that functionality and interrelationship of those components may vary from that described below. Moreover, it will be appreciated that components described below as “programs,” “application” or other software may, in other embodiments, be implemented in hardware and/or firmware and, conversely, that components described below as hardware may, in other embodiments, be partially (or, where applicable, fully) implemented in software and/or firmware.

System Overview

In general, one or more portable communications devices (i.e., mobile platforms) are in communication with one or more content providers over a communications network, which may be owned by a Carrier. A server can also be introduced to interact with the various entities. A printer 15 is provided as well, as discussed further below.

The mobile client 10 is a program that executes on a mobile platform such as a cellular phone. The user interacts with the program to access catalog information and print content. It is understood that a mobile client can be provided by an external source or can be loaded into the mobile platform. As well, a mobile client can be embodied on a mobile platform in a form other than an executable program (e.g., a mobile client can be embodied as firmware and/or hardware).

The server component 100 is a program that runs on a server computer 15 which is accessible from the Internet by the mobile client 10. The server 100 interacts with the client 10 as well as Content Providers 20 and Carriers 30. The server 100 of FIG. 1 has a database component that is used to keep track of user accounts (e.g., the database can be housed in the HAL component 140). The server 100 also has a system management interface 190 that allows an operator to manipulate and configure the server 100.

The server computer can also be embodied as two or more discrete processors working in conjunction, and/or can be accessible through other types of communications networks besides the Internet (e.g., direct telecommunications lines or other type of network). As well, a server can be embodied as hardware and/or firmware, or other embodiments as recognized by those of ordinary skill in the art. Furthermore, the server of FIG. 1 described herein is described with reference to several functional components. Servers consistent with embodiment of the invention can utilize any subset of these functional components, or add additional functional components. As well, particular subsets of functional components of a server can operate on one or more pieces of hardware and/or firmware, or can be embodied as one or more programs that run on one or more processors.

The content provider 20 is an entity which owns content which has inherent value which the user may wish to purchase. Content, for example, may include things like movie tickets, coupons, or other media that can be exchanged for goods, services, or other items of value. The carrier 30 is an entity that owns the network on which the data connection between the mobile client and the server 100 use to communicate. In many cases, the carrier 30 may also own the mobile device that is leased to the user, such as a cellular phone or personal data assistant (PDA).

The various elements of the system in FIG. 1, and their associated potential functions, are described in greater detail herein.

Mobile Client

The mobile client 10 is an application that runs on the mobile device. This application is the system's interface to the user.

The mobile client 10 can perform any number of functions to facilitate communication with a server 100 and other entities, the system in FIG. 1 presenting a particular set of functions. For example, when an item is deposited in the user's mailbox 110, the user is notified in a similar fashion to that of the receipt of voice mail. The method of notification depends on the capability of the mobile device. Methods of notification can include things like a message waiting light and other indicating techniques known to those of ordinary skill in the art.

The mobile client 10 allows the user to browse and query available catalog items. The user can initiate queries with the mobile client 10 such as: “What movie theaters are close to zip code 12345?” The mobile client then gets back from the server 100 a list of catalog items and presents them to the user. The mobile client 10 also allows the user to select items from the catalog listings to acquire. The acquisition may take the form of a purchase of an item, such as a movie ticket, or a “free” item, such as a coupon. When the item is acquired, the server may initiate a transaction on behalf of the user that includes transfer of funds. The acquired item shall then be transferred to the client's mailbox 110 for later printing.

When the user chooses to print an item in the mailbox 110, the mobile client 10 initiates a connection to the server 100 to request the item. The item is then rendered and streamed through the mobile client 10 from the server 100 to the printer 15.

If the mobile client 10 has access to a camera, the mobile client 10 has the ability to capture images from the camera. The mobile client 10 also enables the user to annotate the picture with text, graphics and borders. When a user has completed the capture and annotation, he or she can choose to print the image or send it to another user 40 via multimedia messaging (MMS) or other messaging mechanisms, in which case the image appears in the mailbox 110 of that other user.

Content Rendering Engine

The content rendering engine 120 is a portion of the server 100 that transforms content into a form suitable for printing by the user selected printer. The rendering process takes into account several metrics when deciding how to optimally render the content.

The data bandwidth used to move data from the client 10 to the server 100 is considered when choosing rendering parameters. The rendering engine 120 can trade off image quality for data size, and thus transmission speed, if required.

The color reproduction capabilities of the target printer 15 are also considered when rendering the content. If the printer 15 is a two color, black or white printer, and the content has color components, the rendering engine will dither the source image to suit the capabilities of the target printer 15. The rendering engine 120 also takes into account the color space incompatibilities between the source content and the printer's color capabilities. If the source content has rich color and the printer 15 has limited color reproduction capabilities, the rendering engine 120 will do color mapping to optimize the printed image quality.

The parameter choices that the rendering engine 120 makes to scale content to fit the printer's form factor have a direct relationship to color reproduction and bandwidth. The rendering engine 120 makes trade-offs between color and image quality with this bandwidth utilization in mind.

The rendering engine 120 can also render non-image content, such as text and graphics. If the source content is in HTML form with embedded images, for example, the rendering engine can render this content with the target printer in mind. To support additional formats, the rendering engine 120 uses a pluggable design which allows plug-ins that support new content formats.

Though the content rendering engine shown in FIG. 1 utilizes the aforementioned metrics to create a printable file, other content rendering engines can utilize a subset of the metrics or add one or more additional metrics as known to those of ordinary skill in the art to any number of those previously discussed herein.

Client Proxy

The client proxy 130 is a component in the server architecture 100. This component is point of contact for the mobile client application 10. When the mobile client 10 initiates a connection back to the server 100, the client proxy 130 is the component in the server 100 that fields the connection. Client proxies can carry out a number of functionalities associated with the connection between a server and a mobile client, including the particular set of functionalities described herein with respect to FIG. 1.

When the server 100 wishes to notify the client of a message waiting in their mailbox 110, the server 100 does so by way of the client proxy 130. The client proxy 130 will check to see if there are any messages waiting in the user's mailbox 110 when the mobile client 10 connects, and is connected with the server 100. If there are new messages, the client proxy 130 will notify the mobile client 10, which will in turn assert a message waiting indicator.

The content sent between the mobile client 10 and the client proxy 130 is compressed to conserve bandwidth. The content is also encrypted for the transaction types that require the transmission of sensitive information.

The client proxy 130 will pass along annotated pictures from the mobile client 10 to the nucleus (HAL) 140, which will route the content to another user's mailbox 110 or to the MMS Agent 150, as required.

Nucleus (HAL)

The HAL component 140 is responsible for maintaining the state of the system, through the use of a database. The database is used to maintain information about the users, such as which particular mailbox is assigned to the user and what the user's fulfillment information is, in the event of content purchase.

The HAL component 140 arbitrates communication between the components. If captured photo content is sent from one user to another, for example, the HAL component 140 would handle the transaction.

Post Office

The post office component 110 contains the mailboxes for the users of the system. The post office 110 will initiate message waiting notification to users, by way of the client proxy 130, if the user's mobile client 10 is connected to the server 100.

Content Provider Agent

The content provider agent 160 is an adapter component that facilitates communication between the server 100 and partner content providers 20. The agent 160 adapts catalog queries from the client proxy 130 to the given Content Provider's Business to Business (B2B) interface. This content provider agent 160 allows the content provider specific code to be isolated. As new content providers are added, this component 160 will implement the same interface presented to the rest of the server 100, but the implementation will be tailored to the specific content provider.

The content provider agent 160 presents an interface to the system of FIG. 1 that allows catalog queries of the content provider 20. This interface allows the client proxy 130 to ask the content provider 20 for lists of catalog items that ultimately get passed back to the mobile client 10 and presented to the user.

When the user wishes to acquire an item, the content provider agent 160 presents an interface that allows the execution of the transaction. The catalog item is presented to the interface along with fulfillment information, if the fulfillment is required. At the completion of the transaction, an object or list of objects are given to the agent 160 by the content provider 20. These objects represent the content that was acquired from the content provider 20, such as a movie ticket.

When the system accepts external data, such as a printable object, metadata is carried with the object. The metadata contains information that is the same for all objects from all content providers 20 and information that is specific to the content provider 20 involved in the given transaction (or to that given transaction itself). Examples of metadata that apply to all content providers 20 are things like the date and time that the object was brought into the system. An example of a content provider-specific (or transaction-specific) information is the expiration date of a coupon.

In the event that partner content providers 20 have specific business rules, the system can accommodate this requirement. If the content provider 20 wishes to get notification of the state of an object to be “printed,” the system can execute a rule that results in a notification.

In some models, the content provider 20 may push content to the user, such as location based coupons. The content provider agent 160 can asynchronously receive the content objects mentioned above through this asynchronous receive interface. The objects are then routed to the user's mailbox 110.

Provisioning and Billing Interface

The provisioning interface 170 is used to create new and delete users. The interface 170 is designed to be flexible enough to support the diverse provisioning requirements that the carriers 30 and content providers 20 may have. The billing interface 170 is used to provide fulfillment for purchased items and usage fees, depending on the business model established with the carriers 30 and content providers 20. The provisioning interface 170 also has the ability to provide usage statistics about individual users and groups of users.

Short Message Service/Multimedia Messaging Agent

The short message service/multimedia messaging (SMS/MMS) agent 150 is responsible for any messaging traffic into and out of the system. This component can field messages from external sources, such as content providers 20. This allows leverage of existing broadcast techniques for pushing content to the users. This interface also allows messages to be sent from the system on behalf of a user.

Content Finder Agent

The content finder agent 180 is a component that searches for content based on user preferences. The user, for example, may set the agent 180 to look for coupons for coffee shops based on current GPS location. The user may also sign up for coupons of brands or categories of items. The agent 180 will occasionally search for content that meets the criteria.

Mobile Client to Client Proxy Protocol

The protocol used between the mobile client 10 and the client proxy 130 is required to be flexible to varying payload types, bandwidth friendly for low bandwidth applications, and secure. At the lowest layer, the TCP/IP protocol shall be used at the outset. Other transport protocols can be substituted as needed. The data stream is compressed using a ZipStream encode/decode technique. The data stream is also encrypted. The content of the stream uses XML to contain the objects being passed between the mobile client 10 and the client proxy 130. Non-text objects are encoded using MIME tags, similar to those used for e-mail enclosures. Clearly other types of compression and/or encoding/decoding techniques can be substituted when suitable for accommodating the needs of client proxy 130 and mobile client 10 communication.

The Printer

The printer 15 of the illustrated embodiment in FIG. 1 utilizes multiple heating elements to cause a reaction in thermally activated media to produce a human readable image of data presented to the printer 15 from a portable communications device. Various embodiments of the above printer are envisioned and presented in more detail below.

In one embodiment the printer is connected to a mobile device, such as a cellular phone, via an electrical terminal as well as suitable mechanical means, forming in effect a single instrument. The electrical connector provides a path for transmission of data as well as two way communication controlling functions of the printer, and reporting printer status information to the cell phone, as well as a means for obtaining electrical power from the power source within the cellular phone.

Due to the plurality of cellular phones available, and lack of standard electrical interconnections among the variety of phones, the printer is configured with an easily exchanged module, e.g., a face plate, which could be configured to provide a custom electrically connected interface for a plurality of phones.

Operational information from the printer may be of value to the user; hence such information is made available to the cellular phone and may be interpreted and displayed by the cellular phone for the benefit of the user.

The printer when connected to the cellular phone consists of a number of integral parts, an element with a number of heating elements which respond to data input from the communications source to cause elements to energize. A platen which forms the substrate for these elements, a roller which causes force to be exerted on the platen, a motor and gear elements which respond to an electrical impulse to enact rotation of the roller.

A mechanism which causes a single sheet of thermal sensitive or other media (e.g., roll media, non-thermal media, etc.) to be advanced into the space between the platen and roller and subsequently advance in response to an electrical impulse from control circuitry within the printer, from data provided via the cellular phone.

The action of this media movement through the platen/roller interface causes media to be advanced, as the media advances electrical signals from the circuits within the printer, energize one or more heating elements in response to data provided by the cellular phone which cause a reaction resulting in a readable mark on the media.

The media is subsequently advanced a specified increment and the process is repeated, this process continues until the entire length of one media sheet has been transported through the platen/roller interface and has been energized to form a readable mark in response to the data transferred by the cellular phone.

The printer contains a door or opening accessible to the user for inserting one or multiple sheets of pre cut media into the printer for storage and subsequent printing as described above in response to commands from the cellular phone.

The media may be inserted individually as a group (e.g., in a cassette, as discussed below), or otherwise.

The printer is also equipped with an exit slot which allows the media to emerge from the printer and be made available to the user in the form of a permanent record.

The printer also contains a number of mechanisms which report the status of media in the printer and to monitor a number of functions, including out of media condition, jammed media condition, and insufficient available power to initiate a complete print cycle. This later would prevent a condition were a print cycle was initiated but insufficient power existed to assure completion of the entire print cycle. An algorithm is incorporated to make prior estimates of print cycle energy requirements.

In alternate embodiments, the printer also includes an access so that malfunctions, such as paper jams, or service, such as cleaning the platen, can be accomplished by the user.

An alternate embodiment of the above printer provides for a separate power source, such as a battery as an integral component of the printer. This has the advantage of increasing the overall energy capacity of the system, allowing both the cellular phone and printer to operate on independent power sources.

In utilizing separate power sources the printer could be provided with a recharging means for its internal battery, could operate from a car charger and/or could be configured to share the recharging mechanism provided with the cellular phone, all by way of non-limiting example.

Yet another embodiment would include separate power sources for both the cellular phone and the printer, these power sources could be internally shared increasing the power available individually to either the cellular phone or printer to increase individual operational time.

Another embodiment of the printer retains the printer physically separate and unique from the cellular phone or other communications device, using wireless communications methods, such as Bluetooth, IrDA, WiFi or similar technology, to communicate data to the printer from the communications device and allow transfer of operational information to transmit between the communications device and printer as well as printer to communications device.

Yet another embodiment of the printer is as part of a vehicular communications environment, where, for example, a printer as defined above could form a permanent component within a vehicle. In this embodiment a communications device such as cellular phone or PDA could exchange data with the printer via electrical connector or alternately with a wireless method such as Bluetooth, IrDA, WiFi or similar technology.

When the printer is incorporated into a vehicular communications environment, the power source to operate the printer could be derived from the internal power source of the vehicle, extending the operational capability of the printer.

Printer/Portable communications Device Connection

The requirements on connection mechanism between the mobile client 10 and the printer 15 are increased when the content to be printed has intrinsic value. With normal printing operations, the user can simply try printing the item again. With items of value, the content's value is transferred to paper during to printing operation. If there is an error in this transfer operation and the content is unusable and the system thinks the operation was successful, the value is essentially lost.

A secure connection between the printer 15 and the server 100 can hinder an unintended party from recording the content that is being printed out and producing multiple copies of the item of value. One could conceive that it is possible for an entity to pose as the printer to capture the electronic item. That same entity could then pose as the handset client and “Play back” the content to the printer to print out multiple copies of the item.

In a similar fashion, the connection can be robust enough to guard against “man in the middle” attacks. In this “man in the middle” scenario, an entity is “sniffing” the data passing back and forth between the server 100 and the printer 15. The protocol between the printer 15 and the server 100 is then reverse engineered. With this knowledge, the mobile client 10 is emulated and then provides the ability to print out multiple copies of the item of value.

The connection between the printer 15 and the mobile client 10 can also have enhanced reliability. If data corruption in the transmission of the data between the mobile client and the printer 15 occurs, the corruption must be detected and a retransmission requested. If the corruption is not detected, an artifact in the printed output may occur rendering the printed content useless.

The printer 15 can also have the ability to notify the mobile client 10 of the success or failure to render the item of value to paper. If the printer 15 encounters an error, the printer can notify the mobile client 10 of the error. The mobile client 10 can then inform the user of the error and allow them to retry the printing operation. The mobile client 10 may also notify the server 100 of the error such that error statistics can be collected. The server 100 could notify the content provider 20, administrator and/or others of errors, if the content provider 20 wishes such error notification. The printer 15 is advantageously very robust in its error detection. Errors such as paper jams, and low battery conditions can be detected and reported to the mobile client.

In an exemplary embodiment, a protocol between the printing module and the server uses an encryption algorithm to ensure security. This encryption algorithm provides security by guarding against “man in the middle” attacks as well as “record and playback” attacks. Encryption algorithms include the variety of those utilized by those of ordinary skill in the art, and which are appropriate for use by a printing module and/or a portable communications device (e.g., algorithms which are overly complex to be used by the devices would not optimal). Encryption of a printable file sent from a portable communications device to a printing module can be performed by the server or by the portable communications device. As well, the printing module can be adapted to decode the printable file before creating the printed media. In many instances, a printing module includes a processor and/or other appropriate mechanism in communication with a printer for performing one or more of the connection functions described herein.

In another exemplary embodiment, the protocol between the portable communications device and printing module can include a header with the transferred printable file that contains a predetermined packet length value and checksum to ensure reliability. If the packet checksum, determined by the printing module upon transfer of the packet, does not match, the printing module returns a NACK signal which asks the portable communications device to retransmit the packet. When the packet is successfully processed, the printing module returns an ACK which acknowledges the packet. The protocol can also support a final “printed successfully” message or “error X encountered” message back to the portable communications device. This message notifies the personal communications device of the final disposition of the printed content. Clearly, any one of the functions of this embodiment can be utilized separately in a system or combined with the encryption features previously described.

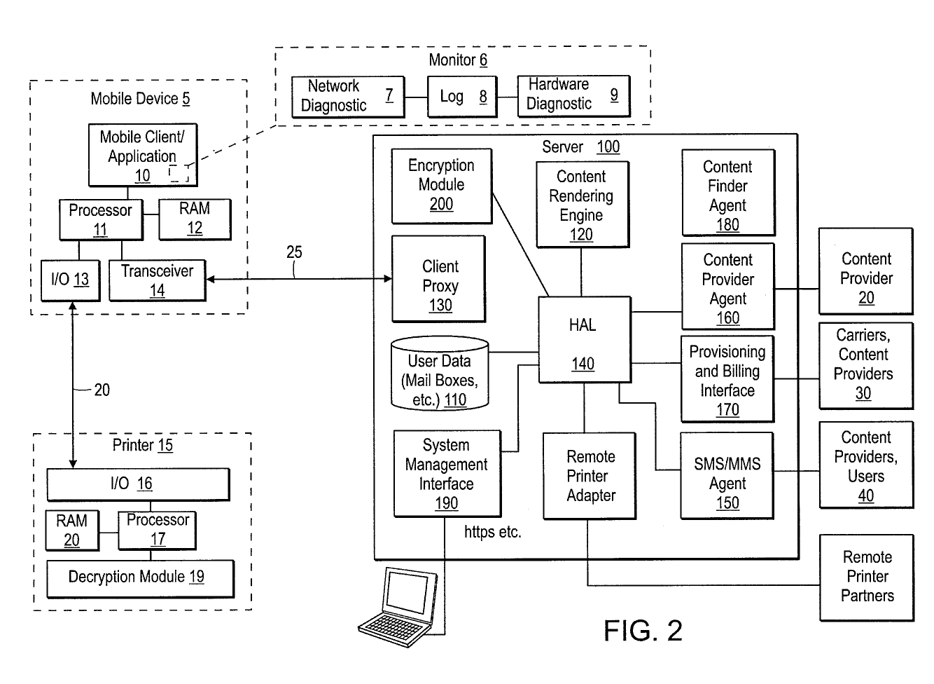

FIG. 2 depicts another embodiment of the system according to the invention for monitoring quality of user experience for mobile client/server application. The system operates in the manner discussed above (e.g., as indicated by use of like element designations) as further modified in view of the discussion below.

Architecture

Referring to FIG. 2, the illustrated embodiment includes, among other things, a mobile device 5, a printer 15, a server 100, a communications link 20, and a LAN/WAN communications link 25, interconnected as shown. The illustrated mobile device 5 comprises a cell phone that is generally configured and operated as described above. Specifically, illustrated cell phone 5 comprises inter alia a processor 11, memory 12, I/O port 13, and transceiver 14. Those skilled in the art will appreciate that in other embodiments the mobile device 5 may comprise a cell phone of differing architecture, or comprise other types of portable, electronic devices (e.g., PDA or otherwise).

The I/O port 13 wirelessly transmits and receives data between the mobile device 5 and the printer 15 and, in the illustrated embodiment, comprises a wireless port that supports one or more wireless protocols (e.g., Bluetooth, WiFi, etc.). In other embodiments, the I/O port 13 may comprise a conventional wired port (e.g., USB, serial, Firewire, etc.) for communication between the mobile device 5 and the printer 15.

The transceiver 14 wirelessly transmits and receives data (encrypted or otherwise) between the mobile device 5 and server 100, although in other embodiments it may also transmit and receive data between the mobile device 5 and printer 15, as well (e.g., in addition to, or instead of, I/O port 13).

The illustrated printer 15, generally configured as described above, further comprises an I/O port 16, processor 17, decryption module 19, and RAM 20, as shown. The I/O port 16 wirelessly transmits and receives data between the printer 15 and the mobile device 5 and, in the illustrated embodiment, comprises a wireless port that supports one or more wireless protocols (e.g., Bluetooth, WiFi, etc.). In other embodiments, the I/O port 16 may comprise a conventional wired port (e.g., USB, serial, Firewire, etc.) for communication between the printer 15 and the mobile device 5.

The illustrated server 100, generally configured as described above, further includes an encryption module 200. The encryption module 200 is implemented in software, though, in other embodiments, the functionality of the encryption module 200 may be handled otherwise (e.g., in hardware, firmware, combinations of hardware and software, etc.).

The illustrated communications link 20 supports secure communication between the mobile device 5 and printer 15, e.g., using a Secure Sockets Layer protocol, Transport Layer Security protocol, or otherwise, and in the illustrated embodiment comprises a wireless connection (e.g., Bluetooth, WiFi, etc.) with 128-bit SSL encryption. In other embodiments, the link 20 may comprise a cable (e.g., USB, serial cable, Firewire, or otherwise) connected between the I/O port 13 and the f/O port 16.

The illustrated LAN/WAN communications link 25 supports secure communication between the mobile device 5 and server 100, e.g., using a Secure Sockets Layer protocol, Transport Layer Security protocol, or otherwise, and in the illustrated embodiment comprises a wireless (e.g., WiFi) internet connection with 128-bit SSL encryption. In other embodiments, however, the link 25 is a wired connection (e.g., USB, etc.) between the mobile device 5 and server 1000, e.g., as discussed above.

Illustrated application 10 comprises a mobile application executing on processor 11, generally configured as described above. In this embodiment, the application 10 includes a monitoring program (or “monitor”) 6 that monitors and logs indicia of the user's experience with the system (e.g., network speeds, mobile device problems, etc.) and, more particularly, the user's experience in obtaining and printing content on printer 15. To this end, illustrated monitor 6 includes a network diagnostic module 7, a hardware diagnostic module 8, and a data log 9, though in other embodiments monitor 6 may be configured otherwise. Although in the illustrated embodiment the monitor 6 is implemented as a software component of application 10 executing on the mobile device 5, in other embodiments it may be implemented otherwise (e.g., as a stand-alone application executing on the mobile device 5 or server 100, as a hardware module on the server 100, etc.).

Illustrated network diagnostic module 7 monitors network accesses by the mobile device 5 and it's components (e.g., application 10), e.g., particularly, in connection with requests for user interface pages (e.g., HTML pages) and content to be printed on printer 15, receipt of such content from server 100 (or otherwise), and transmission of that content to the printer 15 from mobile device 5. To this end, the module 7 can monitor communications over connection 25 between the mobile device 5 and server 100; the connection 20 between the mobile device 5 and the printer 15; and a network of a wireless carrier (e.g., as described above) used by the mobile device 5, just to name a few.

Operation

The embodiment of FIG. 2 generally operates as above, however it is also configured to permit secure, two-way transmission of data (e.g., image data or otherwise) between any of the mobile device 5, server 100, and printer 15. See FIG. 2A. By way of non-limiting example, an application 10 user may want to print a movie ticket. However, according to systems of the prior art, transferred data was vulnerable to hacking, e.g., man in the middle attacks that would allow hackers to print multiple movie tickets. The illustrated embodiment, on the other hand, securely transmits the data between each of the system components, as detailed below, thereby preventing such attacks.

More generally, the application 10 receives requests from users to print a file (e.g., a movie ticket, web page, text, or other data). In order to do so securely, the system relies on the encryption and decryption of transmitted data. In the illustrated embodiment, such encryption and decryption is primarily performed by the encryption module 200 of the server 100, and the decryption module 19 of the printer 15. In other embodiments, however, other aspects of the system may perform such functionality (e.g., functionality built into the processor 17, or otherwise).

As discussed above, a user may acquire data (or “items”) for printing by, e.g., selecting data from a list received from the server 100 and displayed on the mobile device 5. Once the user has made a data selection, the server, via the content provider agent 160, obtains the data from a content provider 20, and stores it, e.g., in the client mailbox 110. In other embodiments, however, the data may generated otherwise (e.g., by the server 100 itself). In order to print the data obtained by the server, a secure connection is created between the printer 15 and the server 100, over which the file is transmitted in encrypted form. As discussed above, the secure connection of the illustrated embodiment uses an SSL protocol, but other embodiments may use other encryption protocols. Moreover, though the illustrated embodiment establishes separate secure connections between the mobile device 5 and printer 15 and between the mobile device 5 and the server 100 (where the mobile device 5 serves as a proxy), other embodiments may establish just a single secure connection between the printer and the server. A secure connection is initiated, for example, by the application 10 sending a request, via the communications link 20, to the printer 15 using a public key encryption algorithm, such as SSL.

After the file is rendered by the engine 120, the encryption module 200 encrypts it. Here, the data is encrypted with an encryption, or cipher, technique supported by the 128-bit SSL protocol, but those skilled in the art will appreciate that a variety of encryption techniques may be used, as well, provided they are supported by the protocol used by the communication links 20 and 25.

As noted above, the embodiment described herein utilizes two SSL-encrypted connections (i.e., one from the printer 15 to the mobile device 10 and the other from the mobile device to the server 100), other embodiments may use just one SSL connection (e.g., one from the printer 15 to the server 100). Still other embodiments may use private-key encryption (e.g., based on DES, AES or other private-key encryption technologies) instead of public-key encryption. In these embodiments, a single private key-encrypted connection can be established, e.g., from the printer 15 to the server 100 (e.g., via links 20, 25), alternatively, two independent such connections can be established between the printer and mobile device, as well as between the mobile device and the server. One such private key-encrypted embodiment (of the single-connection variety) is described in the Appendix hereto.

The server 100 transmits the encrypted, rendered file to the printer 15 via the application 10. More specifically, the encrypted file is sent to the application 10 from the server 100 over the internet connection 25. The application 10 then transmits the encrypted file to the printer 15 over the communications link 20. See FIG. 2D. Thus, the phone application 10 effectively acts as a conduit between the server 100 and printer 15.

Upon delivery of the encrypted data to the printer 15, e.g., at I/O port 16, the processor 17 retrieves the file, and the decryption module 19 attempts to verify that the data is encrypted correctly. If the file was not encrypted correctly, then the file is rejected, and the connection is terminated. However, if the file is encrypted correctly, then the file is decrypted with the decryption module 19, whereupon the printer 15 prints the decrypted, rendered image, e.g., movie ticket. The printing mechanism of the illustrated embodiment is discussed above in detail.

Generally, the monitor 6 monitors the above operations, and reports information associated with those operations to users and/or system administrators, although, in other embodiments, it may report such information to a server, or other entity (e.g., developer, bug reporting database, etc). Thus, for example, when data is successfully printed, the monitor 6 may display a message to the user on the mobile device 5 informing him that a print-job (e.g., for a movie ticket) was completed. Similarly, if the data is not printed successfully, e.g., the session keys do not match, then it may display a message to the user informing him that the print-job failed, and/or transmit that failure to a system administrator to address the problem.

More specifically, as a user executes the application 10, the monitor 6 analyzes and logs performance characteristics of the hardware in the system (e.g., mobile device 5, printer 15, server 100, etc.), and the various communication connections and networks (e.g., connection 20, connection 25, a wireless carrier network, etc., as described above) associated with the mobile device 5. In the illustrated embodiment, the network diagnostic module 7 persistently monitors, and analyzes network performance characteristics, including print transactions, although, in other embodiments it may log or analyze such characteristics at specified intervals (e.g., manually, once an hour, once a day, etc.). Such network performance characteristics can include, to name a few, the amount of time required to send a print request from the mobile device 5 to the server 100 over connection 25; a ping response time from the mobile device 5 to the sever 100; an average network response time of a wireless carrier (e.g., TMobile); or, a time required to load a page from the server 100 in the application 10; all by way of non-limiting example.

The hardware diagnostic module 8 operates in a similar manner to the module 7. In the illustrated embodiment, it persistently monitors and analyzes performance characteristics of the various hardware devices in the system (e.g., mobile device 5, printer 15, server 100, etc.), but in other embodiments it may monitor other devices, as well (e.g., external databases, etc.), and/or monitor the hardware at specified intervals (e.g., manually, once an hour,

The module 7 generates data representing operational characteristics of the connections it monitors, as well as diagnostics representing analysis of that data. For example, the module 7 may determine through monitoring that transmission along all networks and other connections are at expected rates, though, responses from the server 100 are delayed. In such an example, module 7 generates data reflecting current transmission and response rates, as well as diagnostics data indicating responses from server 100 are unexpected delayed. Of course, the module 7 can generate corresponding data when all transmissions and responses up to par, as well.

The illustrated hardware diagnostic module 8 (which, in the illustrated embodiment, is implemented in software) monitors the mobile device 5, printer 15, and other hardware involved in the generation of requests for, receipt and transmission of, content for printing on printer 15. In addition to monitoring device 5 and printer 15, the module 8 may monitor server 100, as well as other resources (e.g., external databases, etc.). The module 8 generates data representing operational characteristics of the hardware and other resources it monitors, as well as diagnostics representing analysis of that data.

For example, the module 8 may monitor the time required to download data from the server 100 to the printer 15, the time required to load user interface pages from the server to the application 10, and/or the printer battery level. If the module 8 determines that any of these values are sub-par, low or otherwise potentially problematic, it generates data reflecting one or more of the respective values (as well as of the other resources it monitors), as well as diagnostics data identifying it as a potential problem source. Of course, the module 8 can generate corresponding data when all monitored components are operating up to par, as well.

Illustrated data log 9 comprises store for data and diagnostics generated by network diagnostic module 7 and the hardware diagnostic module 8. once a day, etc.). Such hardware performance characteristics can include, just to name a few, the utilization of the processors 11 and 17, and the throughput of the I/O devices 13 and 16.

While the modules 7 and 8 are monitoring the system hardware and networks, they respectively generate performance data representing performance characteristics of the monitored hardware and networks, and diagnostic data representing an analysis of such performance data (e.g., problems with the network and/or hardware). Such diagnostic data can include, for example, that the internet connection 25 is transferring information at below average speeds.

The modules 7 and 8 store the operational performance and diagnostic data to the data log 9; although in other embodiments, they may store all or portions of that data elsewhere. Once the operational and diagnostic have been logged, that data is transmitted (or “reported”), e.g., via transceiver 14 over connection 25, to a system administrator, or other administrative entity, for further review. In the illustrated embodiment, the monitor 6 further has the ability to only log and report “problems”, i.e., characteristics that are below standard, such as a slow network connection.

Media Cartridge

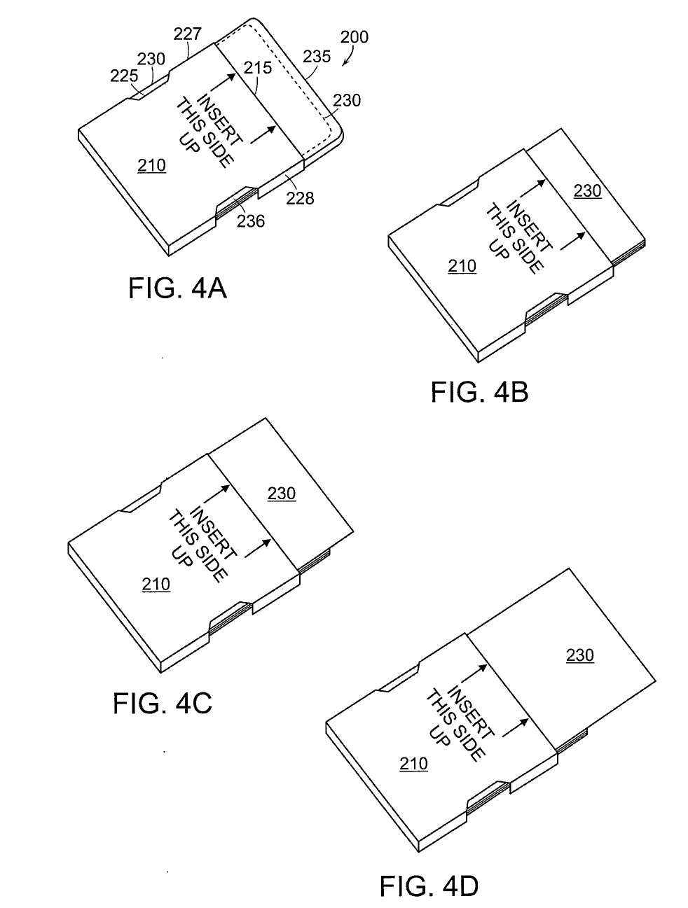

FIGS. 4A-B depict a media cartridge 200 for use in a mobile printing system according to one practice of the invention. The cartridge 200 includes an enclosure 210 and a cover 235, as described below. The enclosure 210 provides a housing in which the media 230 is contained. In the illustrated embodiment, the enclosure 210 is comprised of a rigid material (e.g., plastic, cardboard, etc.), but in other embodiments it may comprise other materials (e.g., flexible materials, metal, paper, cardboard, or otherwise).

The illustrated enclosure 210 generally has a substantially planar shape, i.e., its length and width dimensions are greater than its height dimension. By way of non-limiting example, its dimensions may range from 4″×3″×1″ up to 8″×6″4″. Other embodiments, however, may have differing planar dimensions. The illustrated enclosure 210 further includes an opening along one of its shorter (width-wise) edges 215, e.g., for inserting and extracting the media 230, and regions 225 and 226 disposed on its shorter (length-wise) edges 227 and 228.

The illustrated regions 225 and 226 permit a user to grip the cartridge 200 in such a manner so as to prevent the media 230 from falling out, e.g., during handling, loading and unloading of the cartridge 200. In the illustrated embodiment, the regions 225 and 226 comprise gaps that permit a user to directly grasp the enclosure 210 and the media 230 contained therein, although in other embodiments, the regions may be located elsewhere on the enclosure, and/or be comprised otherwise (e.g., flexible membranes, etc.).

The illustrated enclosure 210 additionally includes designations instructing the user on proper methods of insertion into the mobile printer 15. Such instructions can include informing the user of which “side” of the enclosure should face up during insertion, and which edge (or “end”) of the enclosure 210 should be inserted into the printer 15. In other embodiments, the enclosure 210 may include fewer or other such designations and/or instructions.

The illustrated media 230 comprises individual sheets of paper, or other media appropriate for mobile printing, and is substantially contained within the enclosure 210. In the illustrated embodiment, the media 230 is a stack of sheet paper, or other media but in other embodiments it may be comprised otherwise. By way of non-limiting example, each stack of media 230 may contain ten individual sheets of paper.

In the illustrated embodiment, a portion (e.g., 10%) of the media's 230 surface area is exposed through the opening discussed above. As discussed further below, a cover 235 is included to protect the media 230, e.g., from dust, dirt or other harmful materials. However, other embodiments of the invention may fully contain the media 230 within the enclosure 210, e.g., thereby reducing a need for the cover 235.

The aforementioned cover 235 is removeably attached to the shorter (width-wise) edge 215 of the enclosure 210. In other embodiments, however, the cover 235 is not included. See FIG. 4B. In the illustrated embodiment, the cover 235 is comprised of similar materials as the enclosure 210 (e.g., cardboard, plastic, paper, etc.), and secures the media 235 within the enclosure 210, e.g., during shipping of the cartridge 200 to retailers, etc. Here, the cover 235 is a single sheet a cardboard that is curved to surround the exposed media 230, and the edges of the cardboard are removably inserted into the opening discussed above. In operation, as discussed below, the cover 235 is removed prior to inserting the enclosure 210 into the printer 15.

FIG. 4C and FIG. 4D depict the media cartridge 200 in operation. In the illustrated embodiment, generally, a user inserts a single cartridge 200 into the printer 15, although in other embodiments, multiple such cartridges 200 may be inserted (e.g., in high-capacity printers). If the cartridge 200 includes a cover 235, it is removed prior to insertion into the printer 15, e.g., by gripping the cover 235 and pulling away from the enclosure 210.

Once the cartridge 200 is inserted into the printer 15, the printer 15 extracts individual sheets of media 230 from the enclosure 210 as required for a given print job (e.g., a request sent from the mobile device 5 or server 100 to print a movie ticket), although in other embodiments, the cartridge 200 itself may transfer the media 230 to the printer 15. In the illustrated embodiments, the printer 15 extracts the media 230 through the opening disposed along the width-wise edge 215, as described above. See FIG. 4C and FIG. 4D. Although those figures depict the top sheet of the media being removed from the cartridge first, in alternate embodiments, the bottom sheet of media is removed first. Further discussion of printer operations can be found above.

In some embodiments, the printer 15 will alert a user in the event that an inserted cartridge 200 is empty and/or failing to properly dispense the media 230. By way of non-limiting example, the printer 15 may flash a warning, and/or transmit a warning signal to the mobile device 5, e.g., via communications link 20, for display to the user. In such an event, a user can remove (or eject) the cartridge 210 and either attempt to fix the problem, or insert a new media cartridge in the manner discussed above.

In still other embodiments, the cartridge 200 may include a code indicating the type of media it contains. e.g., black-and-white paper, color paper, photographic-quality paper, and so forth. That code, which can be in the form of a bar or other optical code, a magnetic code, or otherwise, can be utilized by printer 15 in determining how to print on the media In related embodiments, such a code is placed on individual sheets of media.

Described and illustrated herein are embodiments meeting the objects set forth above. Those skilled in art will appreciate that these embodiments are merely examples of the invention and that other embodiments, incorporating changes, therein fall within the scope of our invention. What is claimed is:

1-65. (canceled)

66. A system for user experience quality monitoring in a mobile printing system comprising:
A. a mobile device establishing communication connections with each of a mobile printer and a server,
B. a monitor application executing on the mobile device,
C. the monitor application logging performance characteristics of any of the mobile device, mobile printer, server, and/or communication connections.

67. The system of claim 66, comprising a data log for storing said performance characteristics.

68. The system of claim 66, wherein the data log resides on the mobile device.

69. The system of claim 66, wherein the monitor application generates diagnostic data as a function of the performance characteristics.

70. The system of claim 66, wherein the diagnostic data identifies potential problems with any of the mobile device, printer, server, and/or communication connections.

71. The system of claim 70, wherein the monitor application transmits at least one of the performance characteristics and the diagnostic data from the mobile device to the server via the communication connections.

72. The system of claim 66, wherein the monitor application logs print transactions executed by a user.

73. The system of claim 72, wherein the monitor application displays to a user a status of a logged print transaction.

74. The system of claim 73, wherein the status of a logged print transaction includes at least a value associated with any of a pending print transaction, completed print transaction, or a failed print transaction.

75. A method for user experience quality monitoring in a mobile printing system comprising:
A. establishing communication connections between a mobile device and each of a mobile printer and a server,
B. executing a monitor application on the mobile device,
C. logging performance characteristics of any of the mobile device, mobile printer, server, and/or communication connections, and
D. storing the performance characteristics as data in a data log residing on the mobile device.

76. The method of claim 75, wherein step (E) includes using the performance characteristics in order to generate, and log, diagnostic data specifying one or more problems with any of the mobile device, printer, server, and/or communication connections.

77. The method of claim 75, wherein step (E) includes transmitting the logged performance characteristics from the mobile device to the server via the communication connections.

78. The system of claim 75, wherein step (E) includes logging, with the monitor application, performance characteristics of a carrier network associated with the mobile device.

79. The system of claim 75, wherein step (E) includes logging one or more print transactions executed by a user of the mobile device.

80. The system of claim 79, wherein step (E) further includes displaying a status of a logged print transaction to a user.

81. The system of claim 80, wherein step (E) further includes displaying the status of a logged print transaction, including at least a value associated with any of a pending print transaction, completed print transaction, or a failed print transaction.

82. The system of claim 75, wherein step (E) includes transmitting the performance characteristics to a system administrator via the communication connections in order for the system administrator to address performance problems with any of the mobile device, printer, server, and/or communication connections.

83-92. (canceled)
